(19) United States
(12) Patent Application Publication
(10) Pub. No.: US 2025/0363573 A1
(43) Pub. Date: Nov. 27, 2025

(54) AI Assistant for Delivery

(71) Applicant: Uber Technologies, Inc., San Francisco, CA (US)

(72) Inventors: Dhruv Ghulati, Amsterdam (NL); Nalin Kumar, Bangalore (IN); Anirban Kundu, San Francisco, CA (US); Jaiteerth Patwari, Hyderabad (IN); Sreekanth Sivasankaran, Bengaluru (IN); Narendran Thangarajan, Fremont, CA (US)

(21) Appl. No.: 19/217,747

(22) Filed: May 23, 2025

Related U.S. Application Data
(60) Provisional application No. 63/651,225, filed on May 23, 2024.

(51) Int. Cl. G06Q 50/12; G06F 16/2457; G06Q 30/0601

(52) U.S. Cl. CPC G06Q 50/12; G06F 16/24575; G06Q 30/0605; G06Q 30/0617; G06Q 30/0625; G06Q 30/0631; G06Q 30/0641

(57) ABSTRACT

Systems and methods for providing an AI assistant to users of a food delivery system. The method includes receiving a user query, wherein the user query is associated with a food delivery system. The method further includes accessing contextual data for the user query. The method further includes generating model input, the model input including the user query and the contextual data for the user query. The method further includes providing model input as input to a machine-learned large language model. The method further includes receiving a query response as an output of the machine-learned large language model processing the model input. The method further includes outputting the query response to the user for display, the query response comprising a carousel of selectable options available through the food delivery system.

### PRIORITY CLAIM

The present application is a continuation of U.S. Application No. 63/651,225 having a filing date of May 23, 2024. Applicant claims priority to and the benefit of each of such applications and incorporates all such applications herein by reference in its entirety.

### FIELD

The present disclosure generally relates to a food delivery system that includes an artificial intelligence assistant. More particularly, the present disclosure is related to features for enabling users to effectively access delivery services using an artificial intelligence assistant.

### BACKGROUND

Delivery services, such as food delivery services, allow a user to request a service that may be performed by a vehicle or courier. For instance, a user may request, through a food delivery service application, a food delivery service having a pick-up location, a drop-off location, and an item for delivery. In some circumstances a user may have a query or request that is not easily resolved through existing search features.

### SUMMARY

Aspects and advantages of embodiments of the present disclosure will be set forth in part in the following description, or may be learned from the description, or may be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include receiving, by the computing system, a user query, wherein the user query is associated with a food delivery system. The operations further include accessing, by the computing system, contextual data for the user query. The operations further include generating, by the computing system, model input, the model input including the user query and the contextual data for the user query. The operations further include providing, by the computing system, model input as input to a machine-learned large language model. The operations further include receiving, by the computing system, a query response as an output of the machine-learned large language model processing the model input. The operations further include outputting, by the computing system, the query response to the user for display, wherein the query response comprising a carousel of selectable options available through the food delivery system.

Another example aspect of the present disclosure is directed to a computer-implemented method. The method includes receiving, by the computing system, a user query, wherein the user query is associated with a food delivery system. The method further includes accessing, by the computing system, contextual data for the user query. The method further includes generating, by the computing system, model input, the model input including the user query and the contextual data for the user query. The method further includes providing, by the computing system, model input as input to a machine-learned large language model. The method further includes receiving, by the computing system, a query response as an output of the machine-learned large language model processing the model input. The method further includes outputting, by the computing system, the query response to the user for display, the query response comprising a carousel of selectable options available through the food delivery system.

Yet another example aspect of the present disclosure is directed to one or more non-transitory computer readable media storing instructions that are executable by one or more processors to perform operations. The operations include receiving, by a computing system, a user query, wherein the user query is associated with a food delivery system. The operations further include accessing, by the computing system, contextual data for the user query. The operations further include generating, by the computing system, model input, the model input including the user query and the contextual data for the user query. The operations further include providing, by the computing system, model input as input to a machine-learned large language model. The operations further include receiving, by the computing system, a query response as an output of the machine-learned large language model processing the model input. The operations further include outputting, by the computing system, the query response to the user for display, wherein the query response comprising a carousel of selectable options available through the food delivery system.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for providing responses to user queries using a large language model according to aspects of the present disclosure.

FIG. 2 depicts a block diagram of an example system for providing responses to user queries using a large language model according to aspects of the present disclosure.

FIG. 3 depicts an example flow diagram for providing responses to user queries using a large language model according to aspects of the present disclosure.

FIG. 4 depicts a block diagram of an example system for providing responses to user queries using a large language model according to aspects of the present disclosure.

FIG. 5 depicts a block diagram of an example system for providing responses to user queries submitted by users of a food delivery service using a large language model according to aspects of the present disclosure.

FIG. 6 depicts an example user interface for submitting queries and receiving responses from a large-language model according to aspects of the present disclosure.

FIG. 7 depicts an example user interface for submitting queries and receiving responses from a large-language model according to aspects of the present disclosure.

FIG. 8A depicts a flow chart of an example method for providing responses to user queries using a large language model according to aspects of the present disclosure.

FIG. 8B depicts an example flow chart of an example method for proactively providing responses using a large language model according to aspects of the present disclosure.

FIG. 9 depicts an example system diagram for providing responses to user queries using a large language model according to aspects of the present disclosure.

FIG. 10 depicts a block diagram of an example query response system 1000 for implementing systems and methods according to example embodiments of the present disclosure.

FIG. 11 depicts a block diagram of an example query response system 1100 for implementing systems and methods according to example embodiments of the present disclosure.

FIG. 12 depicts a block diagram of an example query response system 1200 for implementing systems and methods according to example embodiments of the present disclosure.

FIG. 13 depicts an example flow diagram for a method 1300 for using a large language model to supplement a search system according to example embodiments of the present disclosure.

### DETAILED DESCRIPTION

Generally, the present disclosure is directed to systems and methods for using large language models to provide responses to queries from users of a food delivery system. For example, the technology of the present disclosure can enable users to send natural language queries to a food delivery system and receive responses from that system that are more useful than responses generally received from a traditional search system. To do so, a query response system can receive a natural language query from a user. The query response system can access contextual information for that query, including but not limited to, past interactions with users (e.g., if this is an ongoing conversation, the system can access previous queries and responses), stored information for the delivery system (e.g., lists of vendors and associated food items), and user profile information.

The query response system can use this contextual information along with the user query to generate a prompt to a machine learning model. The machine learning model can process the prompt and generate an appropriate response. The response can include a carousel of selectable options available through the food delivery system and a natural language response as part of a conversation. The query response can be transmitted to and displayed to the user in a user interface. The user can select an order, and the food delivery system can generate instructions for the initial delivery of the selected option.

More generally, a food delivery service can be a service that coordinates the delivery of food from vendors or merchants to users. Users can order particular dishes from any associated vendor, and the food delivery service can coordinate a delivery person to bring the food ordered from the vendor (e.g., a restaurant) to the user.

The food delivery service can provide a computer application that is executable on a computing system such as a smartphone or other mobile device that enables users to access the food delivery service. The application can allow user searches to identify restaurants or dishes that meet one or more criteria. The computing application can enable users to select one or more items (e.g., food items), place an order, and make a payment. The application can notify the user when the selected one or more items are expected to be delivered.

However, in some examples, users may have questions or problems that do not fit into a preexisting search system enabled by the application. One method for improving the ability of users to receive responses to their questions includes providing access to a large language model tuned to provide responses to queries associated with the food delivery system.

For example, users may prefer to ask questions or make requests using natural language. For example, a user may prefer to enter text such as “What is a good pasta dish nearby?” Traditional search techniques may have difficulty correctly responding to the user with useful recommendations. However, machine-learned models can be trained to respond to this type of natural language question accurately and appropriately. More specifically, large language models (or other generative models) can be trained to respond to queries for a variety of different situations or contexts.

In some examples, the machine-learned model can be trained specifically to provide responses to queries from users of a food delivery system. In other examples, the food delivery system can use a generally trained machine-learned model and prompt it to produce results suitable for users of the food delivery system.

The food delivery system can use an AI assistant to coordinate between a system that receives the queries and the machine-learned model. For example, the application associated with the food delivery system can include a chat interface. The chat interface can allow users to input natural language queries. The AI assistant can perform some preprocessing on the query language. In some examples, the AI assistant can generate a prompt as input to the machine-learned model (e.g., the LLM). In some examples, the prompt can include, among other elements, contextual information for the user query that would enable the machine-learned model to produce output suited for use in the food delivery application. The AI assistant can determine the particular context to include, based at least in part on an analysis of the text of the query.

The machine-learned model can take the prompt as input and generate model output. In some examples, the model output can include natural language responses to user queries. In other examples, the output of the model can provide specific information to be used by the food delivery system. The prompt can include information directing the machine-learned model to generate an output with a specific structure and including specific information.

In some examples, the prompt instructions can direct the machine-learned model to produce output that can be used to interact with a searchable product catalog for the food delivery service. For example, the output of the machine-learned model can include a classification of the user's intent. For example, the output can classify the user query as one of a plurality of candidate user intents. The candidate user intents can include, but are not limited to, food or restaurant recommendations, information requests, the re-order of a previous order, or a follow-up on an earlier query.

The output can include specific information about filters or search terms to be used when searching a database of products or vendors (e.g., restaurants). The LLM can be instructed to provide specific information describing searchable entities such as restaurant names, item names, cuisine preferences, food categories, etc. Also, the user query may indicate specific filters of interest such as promotions, price buckets, menu price, delivery time, delivery price, pick-up/delivery/schedule, etc. The prompt to the LLM can include specific instructions to provide specific information associated with the user indicated filters. The output can use a schema defined in the prompt instructions so that the food delivery system can easily use the output to perform searches and so on.

The AI assistant can receive the output from the machine-learned model. If the output includes one or more searches or filters, the AI assistant can coordinate with the search system to provide the searches and receive the results. The AI assistant can format the search results for display to the user. In some examples, the search results can be displayed in a visual carousel. The visual carousel can display a plurality of items (e.g., recommended food items) along with an image for each item and information about each item. Only a portion of the plurality of items are displayed at a given time, and a user can select an interface element (e.g., a button that acts as a tool enabling the user to manipulate the carousel) to turn the visual carousel to see additional items.

In some examples, the user can ask a follow-up question. The interactions between the user and the AI assistant can simulate a natural language conversation and be supplemented with search results (e.g., presented in the visual carousel). The user can also select one of the displayed options to order. The user selection can be made using natural language chat inputs (e.g., “order the Beef Wellington from restaurant A”) or through the selection of a user interface element associated with the desired item (e.g., clicking on an “order” button associated with a particular item). The food delivery service can take payment and arrange delivery of the selected item.

In some examples, the AI assistant can proactively provide suggestions and recommendations to the user without the user needing to make an explicit request to the system. For example, when the user interacts with the application associated with the food delivery system, the AI Assistant can analyze user data (including the user history) and proactively make recommendations to the user. For example, if the user has a regular schedule of ordering a particular food item, the AI assistant can predict the next time the user may want to order that food item. The suggestion can be surfaced to the user in the application as a pop-up element. In other examples, the suggestion can be transmitted to the user as a notification on their smartphone. In another example, the AI Assistant can analyze the typical grocery items purchased by the user and their frequency to determine a purchasing pattern (e.g., paper towels every two weeks) and use that to suggest purchases proactively.

In another example, the AI assistant may have access to data indicative of typical expiration dates of previously ordered items and suggest the user replace or re-order the item. For example, if the user has previously ordered deli turkey, the AI assistant can determine when the deli turkey will expire and prompt the user to re-order in a timely manner. In another example, the AI assistant can access travel data (e.g., via a ride-sharing service or navigation application) to determine that a user is traveling to a particular location (with the user's explicit permission). Based on this information, the AI assistant can suggest a particular purchase. For example, if a user has planned a trip to the beach, the AI assistant can proactively suggest purchasing sunscreen. The suggestion (e.g., notification) can include a link or other UI element to order the sunscreen via the delivery service.

The systems and methods of the present disclosure provide a number of technical effects and benefits. As one example, the system and methods can provide increased accuracy in responding to user requests in an item delivery environment. In particular, the systems and methods disclosed herein can automatically respond to a user's request, even if that request is in a non-standard format.

Another technical benefit of the solutions described herein includes integrating existing content (e.g., stored information about products and vendors) with natural language responses provided by a large language model. Specifically, displaying recommended products in a visual carousel in a chat interface enables a user to more quickly and easily receive accurate responses to the user's queries. Moreover, the system and the AI assistant can be configured to proactively provide recommendations to the user, without a user query. As such, the technology of the present disclosure decreases the amount and frequency of user input (e.g., searches, scrolling, selection/de-selection) and, thereby, reduces the amount of processing and memory resources used by the computing systems to process such input.

The technology described herein introduces a novel way of presenting user recommendations to a user with minimal additional cost and time. Thus, it solves the problem of presenting existing data with the output of a large language model to the user. The solutions reduce the cost of responding to user requests while increasing user satisfaction.

The following will now describe example embodiments in greater detail. The example embodiments include the use of user-related data. Such data can be securely stored and transmitted with, for example, encryption and passwords. The collection of user-related data can be optional, and in each example, the user can choose to decline or opt out of the collection of user-related data.

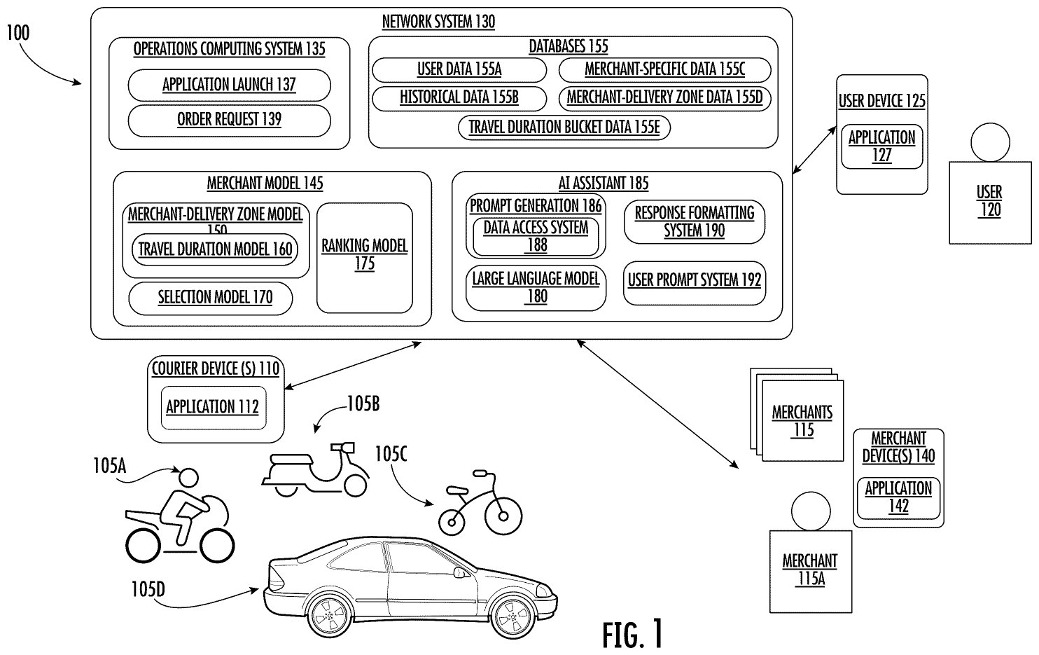

FIG. 1 depicts a block diagram of an example system 100 for providing an artificial assistance system for users of an item delivery system according to aspects of the present disclosure. As illustrated, FIG. 1 shows a system 100 that can include one or more vehicles 105A-105D (e.g., a car, scooter, motorcycle, bicycle) and one or more courier devices 110 that can be associated with one or more couriers. In some examples, the one or more couriers are humans. In some examples, the couriers can be non-human (e.g., vehicle, autonomous vehicle, autonomous robot). The one or more couriers and the one or more courier devices 110 (e.g., an onboard tablet, a mobile device of a courier) can be associated with the one or more vehicles 105A-105D. The courier device(s) 110 can include a software application 112 associated with the food delivery service entity, which can run on the courier device(s) 110. The computing system 100 can include one or more merchants 115. The merchants 115 can receive data indicative of a food delivery service request from a user 120.

For example, the user 120 can initiate a delivery service session (e.g., via a software application such as application 127). In some instances, the user 120 can submit a request through a user device 125 associated with the user (e.g., via a software application such as application 127). A network system 130 can include a computing system associated with a service entity that can facilitate a request for services from user 120. An operations computing system 135 associated with the food delivery service entity can facilitate a request for services from user 120. For example, the user 120 can submit a food delivery request through a user device 125 associated with the user 120 (e.g., via a software application such as application 127). Operations computing system 135 can receive data indicative of an application launch 137 or an order request 139 from a user device 125. Data indicative of application launch 137 can be transmitted automatically in response to determining that the service application 127 has launched (e.g., been opened or otherwise initiated on user device 125). The operations computing system 135 can send data indicative of order request 139 to a merchant device 140 associated with a merchant 115A (e.g., via a software application such as application 142).

The network system 130 (e.g., operations computing system 135) can access or store one or more merchant models 145 and databases 155. The data stored in databases 155 can include user data 155A, historical data 155B, merchant-specific data 155C, merchant-delivery zone data 155D, or travel duration bucket data 155E. The merchant models 145 can use data stored in databases 155 or populate databases 155 with data generated by the merchant models 145. The use and generation of such data is discussed herein.

Merchant-delivery zone model 150 can utilize data indicative of the number of merchants 115 to generate a bucketized data structure. The operations computing system 135 can receive data indicative of a number of merchants 115. For instance, the data can include merchant-specific data 155C, such as merchant location, inventory, store type, cuisine type, average time to shop, or other relevant data. By way of example, merchant-delivery zone model 150 can use merchant-specific data 155C and travel duration model 160 (e.g., isochrone model, haversine model, merchant's delivery zone mapping model) to determine a travel duration between each respective merchant of the number of merchants 115 and various predefined delivery zones associated with a geographic area. Travel durations can include temporal or physical distance durations (e.g., haversine distance). In some instances, travel durations can be determined at the point a merchant onboards to the delivery service and can be updated at a regular or irregular cadence. The travel durations, if temporal based, can vary depending on the time of day, day of week, season, etc.

The merchants 115 can be selected or ranked by merchant ranking model 175. For instance, responsive to obtaining data indicative of an application launch 137 or data associated with a user searching for recommendations within a specified travel duration, the merchants can be selected using selection model 170 or ranked using ranking model 175. Selection model 170 can utilize travel duration bucket data 155E to generate a selection of a subset of merchants. In some implementations, selection model 170 and ranking model 175 can be the same model. In some implementations, selection model 170 and ranking model 175 can be distinct models.

Ranking model 175 can use user data 155A, historical data 155B, or merchant-specific data 155C in ranking the subset of merchants. User data 155A can include data associated with user 120. Historical data 155B can include data associated with user 120, data associated with merchants 115, or data associated with couriers. Other relevant data can be utilized by selection model 170 or ranking model 175. For instance, other relevant data can include system-level data associated with a number of users or expected demand.

Merchant-specific data 155C can include location, cuisine type, customer reviews and ratings, preparation time, food options, menu, payment options, certifications, dietary information, operating hours, contact information, name, and more for merchant ranking. In some embodiments, merchant-specific data 155C can be indicative of a merchant 115A accepting a food preparation request (e.g., food being prepared, estimated preparation time).

AI assistant 185 can provide a natural language query service to a user of the application 127. Users can, through a chat interface included in the application 127, input natural language queries. The query analysis system can access the query and perform one or more preprocessing steps. The preprocessing steps can include determining whether the AI assistant 185 is to access additional data to provide, as context, with the query to the large language model 180.

The prompt generation system 186 can receive the query from the query analysis system. Based on the analysis performed by the query analysis system, the prompt generation system 186 can access relevant data using the data access system 188. The data access system 188 can access, among other data, user data 155A, historical data 155B, and data describing previously submitted queries and responses.

The prompt generation system 186 can generate input to the machine-learned model. The input can be a prompt. The prompt can include the query, relevant contextual data, and instructions for the LLM describing the requested output. As described above, the requested output can be data formatted according to a particular schema that can be used to search and filter information from the databases 155.

The large language model 180 can provide a response in the form of model output. The model output can be organized based on the format requested by the prompt. In some examples, the model output can be used to generate a response for the user 120. In some examples, the response includes natural language explaining one or more aspects of the response. In some examples, the response formatting system 190 can generate a response that includes a list of items (e.g., dishes) and/or vendors (e.g., restaurants). In some examples, the list of items can be displayed in a carousel format. The carousel format can display recommendations (or search results) horizontally, with at least two other interface elements. Specifically, the carousel can include a left button and a right button. When selecting one of the two buttons, the carousel can rotate the displayed items in the indicated direction. As the carousel rotates, some items can be rotated out of the display area, and others can be rotated into the display area. The visual created by this displayed carousel can visually simulate a turning shelf or carousel.

The query response can be transmitted to the user device 125. The user device 125 can display the query response to the user 120. The query response can be displayed in a chat interface. The query response can be displayed in a chat interface conversationally (e.g., using natural language and incorporating additional context into the response).

The user prompt system 192 can provide suggestions and recommendations to the user without the user needing to make a request to the system explicitly. For example, when the user interacts with the application (e.g., browsing through menus and so on) associated with the food delivery system, the user prompt system 192 can analyze user data (including the user history) and proactively make recommendations to the user. For example, if the user has a regular schedule of ordering food items, the user prompt system 192 can predict the next time the user may want a food item. The suggestion can be presented to the user in the application as a pop-up element. In other examples, AI assistant 185 can transmit suggestions to the user's device as a notification on their smartphone. In another example, the user prompt system 192 can determine typical grocery items that are purchased by the user (e.g., based on past purchase frequency) and determine a purchasing pattern (e.g., paper towels every two weeks). The user prompt system 192 can proactively suggest purchases to a user based on the determined purchasing pattern.

The operations computing system 135 can transmit data including instructions that, when executed by user device 125, cause a user interface associated with application 127 to display the ranked merchants. The operations computing system 135 can obtain user data indicative of a selection of one or more items from one or more merchants as part of order request 139.

The operations computing system 135 can generate data indicative of an order request 139 (e.g., estimated time of departure, estimated time of arrival, estimated preparation time, real-time updates on order preparation, real-time updates on order location). The operations computing system 135 can provide data for display on a user device 125 (e.g., via application 127) indicative of updates on the order request 139. For example, an update can include an update about what stage of delivery the primary order is in (e.g., preparation, pick-up by courier, courier in route, approaching delivery, delivered).

An operations computing system 135 associated with the service entity can receive an order request 139 from the user device 125. The operations computing system 135 can send a request to a courier device 110 associated with a courier (e.g., via a software application 112) for the courier to perform the requested primary order request service. The courier can be associated with the vehicle (e.g., vehicle 105A-105D).

The operations computing system 135 can communicate data indicative of the delivery service assignment to a courier (e.g., a human courier, an autonomous vehicle courier, an autonomous robot courier). For instance, the operations computing system 135 can send a request to the courier device 110 of the courier. The request (e.g., for the courier to accept the delivery service assignment) can be communicated to the courier via the software application 112 running on the courier device 110 associated with the courier. Additionally, or alternatively, the operations computing system 135 can send a request to a courier device(s) 110 (e.g., a tablet stored onboard the vehicle) of at least one of vehicles 105A-105D. The request (for the courier to accept the delivery service assignment) can be communicated to the courier via the software application 112 running on a courier device 110. The courier can provide user input to the courier device 110 (e.g., via the software application 112) to accept or decline the vehicle service assignment. In some examples, user input can be provided directly into a service application. Additionally, or alternatively, user input can be provided via an application programming interface (API) or a third-party application. Data indicative of the acceptance or rejection of the request can be provided to the operations computing system 135.

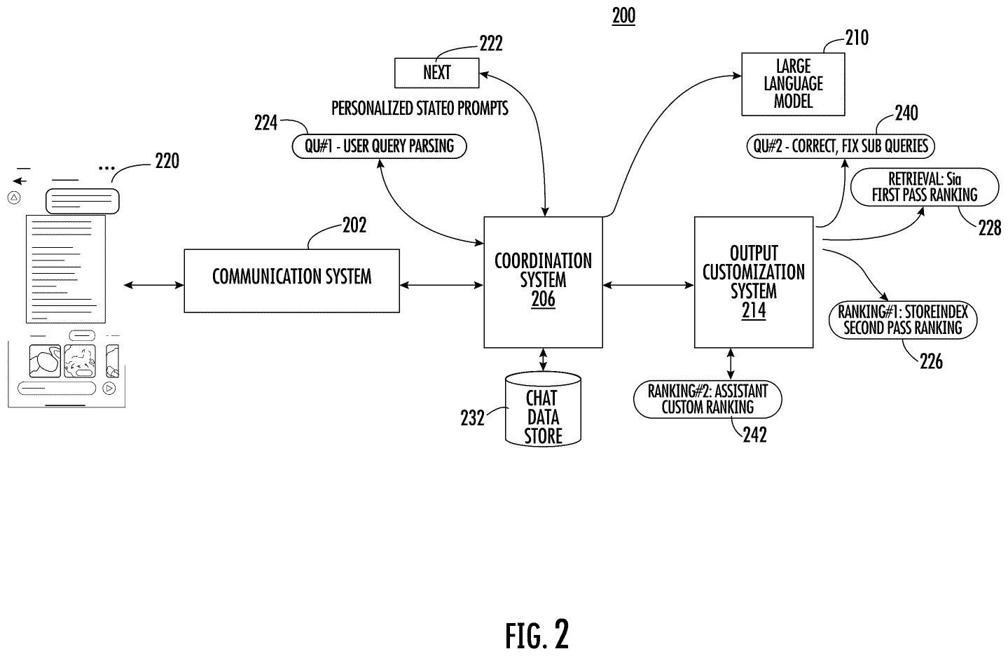

FIG. 2 depicts an example system architecture for an AI assistant 200 according to aspects of the present disclosure. The AI assistant 200 can include a communication system 202, a coordination system 206, a large language model 210, an output customization system 214, and a chat data store 232.

In some examples, the communication system 202 can enable users to provide input via a chat interface. For example, users can submit queries 220 in a natural language format in the chat system window. The communication system 202 can determine whether the query submitted by the user is appropriate for that AI assistant 200. In some examples, the communication system 202 can determine that specific queries are suitable for the AI assistant system 200, and others are appropriate for the traditional search system.

The communication system 202 can facilitate chat between the user and the coordination system 206. For example, the communication system 202 can include a switchboard system that can create threads, send messages, update threads, and perform other functions needed to enable a chat system between a user and an AI assistant.

In some examples, the communication system 202 can create chat threads between a user and an AI assistant via the coordination system 206. Each thread can have a specific thread identifier. The thread can represent a collection of messages between two or more entities (e.g., users, support personnel, the AI assistant and so on). When a thread is created, the communication system (or a switchboard included in the communication system 202) determines whether any existing threads have the same identifier value. If not, the thread is created with two or more participants. If an existing thread has the same identifier, thread creation fails, and the communication system can attempt to generate another thread with a different identifier.

Once the thread has been created, participants of the thread can send messages to other participants of the thread. Messages can be of different types such as text, system messages, images, and so on. The communication system 202 can update the thread to alter the thread participants (e.g., add a support person) or indicate specific thread activity (e.g., typing status details).

In some examples, the interface of a chat system can display selectable prompts that the user can select. The displayed selectable prompts can be personalized based on user account data (e.g., user preferences, previous prompts, previous orders, and so on).

In some examples, the AI assistant may send the first message in a newly created thread (e.g., based on the context in which the thread was created or based on past interactions with the user). The communication system 202 can include a library that enables base chat functionality. In other examples, the communication system 202 may wait until a message is received from the user before presenting messages from the AI assistant. The user can send a message that includes a user query.

The communication system 202 can pass the user query to the coordination system 206. The coordination system 206 can include one or more sub-systems that enable the AI assistant 200 to interact with a series of supportive systems to generate the best response for the user's query. For example, the coordination system 206 can access the user query parsing system 224. The query parsing system 224 can analyze the user query to extract relevant data from the query itself. Relevant data can include information about the content of the query, such as particular items (e.g., restaurants, dishes, and so on) mentioned explicitly in the query. The query parsing system 224 can provide contextual information based on the extracted data. This contextual information can be included as input to the large language model 220. The contextual information can be submitted to the large language model can be determined based on the submitted query.

In some examples, the coordination system 206 can generate personalized prompts based on the parsed query. For instance, the coordination system 206 can employ a prompt personalizer system 222 to generate one or more personalized prompts. Personalized prompts can include information about chat history from the chat data store 232. The coordination system 206 can provide the generated prompt or other inputs to the large language model 210.

The large language model 210 can determine query intent and can provide structured output information that can be used to search existing restaurant and item databases to provide a more helpful response to a user. The output of the large language model 210 can be provided to the coordination system 206. The coordination system 206 can use an output customization system 214 to insert supplemental information retrieved from the data stored with the item delivery system. The supplemental information can include images of particular items, information about those items, prices, availability, delivery times, total costs, and so on.

For example, the output customization system 214 can generate or correct one or more sub-queries 240 based on the output of the large language model 210. The output customization system 214 can execute one or more subqueries through the standard search system of the item delivery system. The search system can return data 228 based on the output of the large language model 220 (e.g., search terms and filters provided by the LLM 202) to determine candidate recommendations for food items to be delivered to the user. The prompt can include instructions providing details on the specific format that the output of the model output should take (e.g., a requested output schema). Thus, the model output is customized so the output customization system 214 can quickly generate recommendations based on the items available through the item delivery system. The output from the LLM can be customized by ranking the candidate recommendations at 242 or 226. The output customization system 214 can transmit the response (e.g., customized output from the LLM 220) through the communications system 202 to the user computing device from which the query was received. The interface of the chat window can be updated to include the query response.

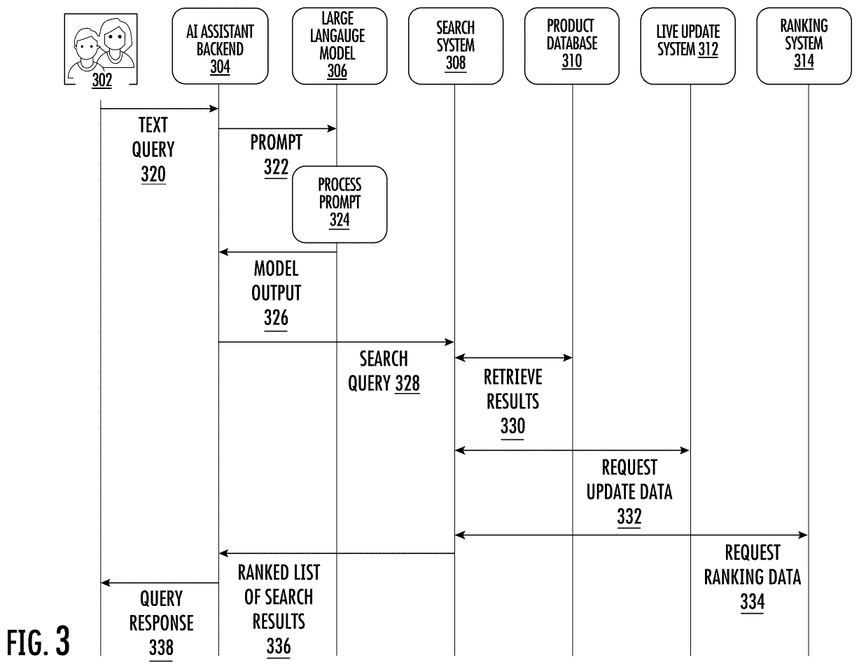

FIG. 3 is an example flow for providing user interaction with an AI assistant while using an item delivery service in accordance with an example embodiment of the present disclosure. In some examples, a user 302 can provide a textual query 320 to the item delivery system via an interface included in an application on the user's computing device. The item delivery system can use an AI assistant to provide the query to the AI assistant backend 304. For example, the user query can be a natural language question, such as “suggest to me Chinese dishes under $20 delivered in 30 minutes.” The AI assistant backend 304 can receive the textual query 320 (also referred to as an input query). Based on the received textual query 320, the AI assistant backend 304 can generate input to a model.

Input to a model can be referred to as a prompt 322. In this example, the prompt 322 can include the textual query 320 from the user, response instructions, chat history from the current chat session, any user information that may be useful in understanding the textual query 320, information about menu items available from the food delivery service, and any prompted instructions associated with the food delivery service that enables the model to provide better results for users of the food delivery system.

Once the prompt 322 has been generated, the prompt 322 can be provided as input to the large language model 306. The prompt 322 can include instructions detailing how the large language model 306 should respond to the prompt 322. For example, the prompt 322 can instruct the large language model 306 to detect the user's intent, generate recommendations, extract potential attributes, and generate filters associated with the item delivery system.

The large-language model 306 can, at 324, process the prompt 322. In some examples, processing the prompt 322 can include detecting intent from the textual query 320, generating recommendations based on the textual query 320, extracting entities from the textual query 320, and generating filters based on the textual query 320.

After processing the prompt 322, the large language model 306 can generate a model output 326. The model output 326 from the large language model 306 can be information that can be used to generate a search using the search system 308. For example, the machine-learned model 306 can be trained specifically to generate model output 326 that includes search terms, entities, filters, and so on. The model output 326 can be formatted as JSON. The model output 326 can include information that can be used to search the search system 308.

The model output 326 can be provided to the AI assistant backend 304. The AI assistant backend 304 can generate a search query 328 based on the model output 326. In some examples, the AI assistant can transmit the search query 328 to the search system 308. For example, the AI assistant backend 304 can call the search functional of the search system 308 by providing the search query 328 to the search system 308.

The search system 308 can retrieve results 330 from the product database 310. In some examples, the product database 310 can store a plurality of items and a plurality of merchants (e.g., restaurants, grocery stores, and so on). In some examples, the product database can, for each merchant, store an associated list of products, services, or dishes provided by the merchant. The search system 308 can transmit a list of search fields including search entities, filters, and so on.

The product database 310 can return a list of search results. The list of search results can include results that represent matching merchants and results that represent matching items. The search system 308 can request update data from the live update system 312. The additional data can include availability data for the search results. For example, the live update system 312 can include data representing which merchants are currently available (e.g., the merchant's operating hours) and which items are available (e.g., which items are currently in stock). For example, the search system 308 can have a plurality of food vendors available through the food delivery system and information about the food offered by each vendor. The additional information can include other contextual information about the items or merchants (e.g., cost, location, images of the item, etc.).

The search system 308 can request ranking data 334 from the ranking system 314. The requested ranking data can include information that can be used to rank the list of search results 330, such as information about product types, categories, location, cost, user preference data, user history data, user ratings of the items or merchants, and so on. The search system can generate a ranked list of search results using the ranking data and the list of search results.

The search system 308 can return the ranked list of search results 336 to the AI assistant backend 304. As noted above, the ranked list of search results 336 have been filtered, ranked, and additional supporting information (e.g., location, price, images, etc.) have been added. The AI assistant backend 304 can generate display information for presenting the ranked list of search results 336 at the user computing device of the user 302.

The AI assistant backend 304 can transmit the ranked list of search results 336 and any display information (e.g., formatting information used to display the ranked list of search results 336 in an item carousel or other display format.) to the user computing device as a query response 338. The user computing device can display the query response 338 (e.g., the ranked list of search results 336) to the user.

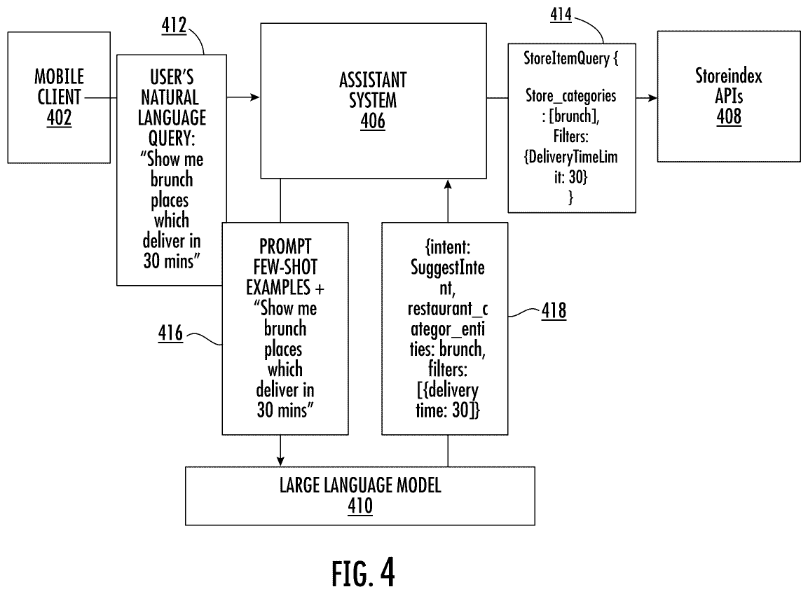

FIG. 4 depicts a block diagram of an example system for providing responses to user queries using a large language model 410 according to aspects of the present disclosure. A user can enter a natural language query 412 through an application executed by a mobile computing device 402 (e.g., a smartphone or other computing device). For example, the application can be associated with an item delivery system and can include an input area (e.g., an input field) where a user can input a query. In some examples, the input area is part of a chat window, enabling users to send natural language queries 412 and receive appropriate responses.

In this example, the user sends a natural language query 412 that states, “Show me brunch places which deliver in 30 mins.” The natural language query 412 will be received by an assistant system 406. The assistant system 406 can use the natural language query 412 to generate input for the large language model 410. The input to the large language model 410 can be a prompt 416. The prompt 416 can include natural language query 412, one or more few-shot examples, and instructions for the type of output the large language model 410 is requested to provide. In addition, the prompt 416 can also include previous statements from the user in the conversation. The few-shot example(s) can allow the pre-trained large language model 410 to generalize over new categories of data (that the pre-trained large language model 410 has not seen during training) using only a few labeled samples per class.

The large language model 410 can be tuned to provide two types of output to the assistant system 406. In some examples, the output 418 of the large language model 410 can include user intent classification. The user intent classification can include information about the type of natural language query 412 the user has provided. The output can also include relevant information from the input query, such as particular food types, restaurants, locations, and so on.

In some examples, the output 418 can classify that the user intent is associated with searching for specific restaurants or dishes. In other examples, the output 418 can classify that the user intent is to receive recommendations for particular restaurants or dishes. In some examples, the model output can indicate that the user's intent is to re-order a particular item.

In addition to determining (or classifying) the user's query intent, the large language model 410 can extract relevant information from the query for use in providing an accurate response to the user's query. For example, the large language model 410 can determine whether the query includes searchable entities such as restaurant names, item names, cuisine preferences, food categories, etc. The assistant system 406 can determine whether the query indicates any filters. Filters can include, but are not limited to: promotions, price buckets, menu price, delivery time, delivery price, pick-up delivery schedule, etc. The assistant system 406 can also determine whether the user query indicates a particular location in the query.

In some examples, the output from the large language model 410 can also include information generated directly from the large language model knowledge base. For example, the large language model 410 can provide recommendations and responses to the user's query as needed. This information can be transmitted to the user device for display to the user. In some examples, the query response can include clarifying queries or responses that reference previous queries submitted by the user to simulate an ongoing conversation in a natural language style. For example, if the user asks for information about the best Italian restaurant in the area, the assistant system 406 can, based on the output from the large language model 410, search and filter restaurant data in its vendor database to determine the highest-rated restaurants that provide Italian cuisine. In addition, the output from the large language model 410 can also include natural language describing additional context or offering extra options to the user.

Once the user intent classification has been received, the assistant system 406 can use that information to generate a system instruction 414 for one or more APIs 408 associated with the food delivery system. For example, the LLM 410 can extract the particular intent, location, delivery time, and so on from the natural language query 412 (and other information included in the prompt). Based on the extracted data, the assistant system 406 can generate the system instruction 414 to include a filter or search query for the database stored by the food delivery system.

The specific API 408 to execute the system instruction 414 can be selected based on the determined intent. The assistant system 406 can then route the system instruction 414 to one of a plurality of potential handlers. For example, suppose the user is looking for a recommendation. In that case, the system instruction 414 can be routed to a recommendation system, which can use complex filters to determine particular restaurants or dishes to recommend to the user.

If the user intent is a search for a particular item or restaurant, the terms of the search can be extracted from the output 418 and included in the system instructions 414. The system instructions 414 can be provided to the search system, which can use complex filters to identify a particular matching restaurant or dish. If the model output indicates the user has follow-up intent, the assistant system 406 can transmit the system instruction 414 to a system that can follow up on a previous query from the user. For example, the system instruction 414 can indicate that the user intends to gather more information. In this example, the user can be provided with information about the particular stores or items they are searching for.

In some examples, the user intent can be determined to be reordering a particular item. In this case, the assistant system 406 can generate an order based on information in the model output 418 and included it in a system instruction 414. The system instruction 414 can be passed to the ordering system or the re-ordering system to identify past orders and select a particular order the user refers to. In some examples, the output of the large language model 410 indicates that the intent of the user is outside of the scope of the AI assistant. In this case, the large language model 410 may generate a general response, or the user may be notified that the assistant system 406 is unable to provide a response to that particular query.

Thus, the assistant system 406 can provide the system instruction 414 to the appropriate API 408. Once the system instruction 414 has been executed, the results of executing the system instruction 414 can be provided to the user. For example, if the input query was a search for a particular food item, the results with be search results listing a series of potential matching food items. The search results can be transmitted to the requesting user computing device for display to the user.

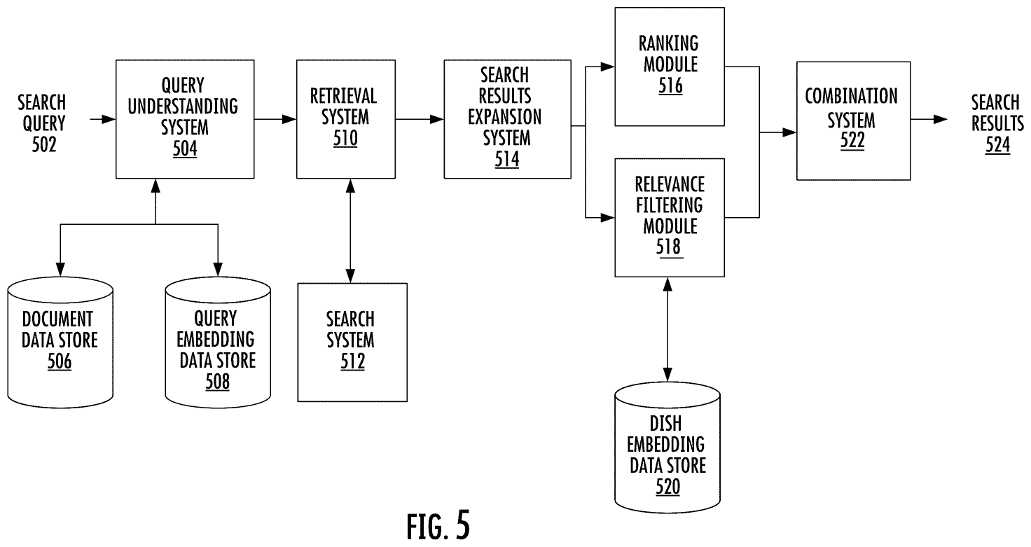

FIG. 5 describes a system for implementing search associated with a food delivery system in accordance with example embodiments of the present disclosure. In this example, the search query 502 can be provided to the query understanding system 504. The query understanding system 504 can extract various attributes from the query. The query understanding system 504 can use information stored in the document storage data store 506 and a query embeddings data store 508 to understand and extract the appropriate attributes from the query. The query embeddings data store 508 can be used to retrieve query embeddings.

Once the query understanding system 504 has processed the query, a retrieval system 510 can send queries to a search system 512 to retrieve a list of one or more search results (e.g., restaurants, dishes, etc.) based on the attributes of the search query. The search system 512 can return a list of search results based on the search query to the retrieval system 510.

The retrieval system 510 can transmit the returned search results (e.g., a list of stores, restaurants, food items, dishes, etc.) to the search results expansion system 514. The search results expansion system 514 can provide additional details for the list of vendors and products by supplying vendor and item information not stored in the original search system. The search results expansion system 514 can pass the expanded search results to a ranking module 516 and a relevance filtering module 518. The ranking module 516 can rank the list of vendors and products. The relevance filter module 518 can access embedding data, computed dot product scores, and filter items based on a predetermined threshold of quality or relevance. Any items that do not meet the predetermined threshold can be discarded.

For example, the relevance filtering module 518 can calculate a relevance score for each search result in the expanded search result. The relevance score can be a value between 0 and 1 (with 1 being the most relevant and 0 being the least relevant). If the predetermined threshold is determined to be 0.8, any search result with a relevance score below 0.8 will be determined to not satisfy the predetermined threshold and will be discarded. Conversely, any search result with a relevance score above 0.8 can be determined to meet the predetermined threshold and will not be discarded. In some examples, the relevance filtering module can use information from the dish embedding data store 520 to calculate a relevance score for a particular search result.

A combination system 522 can combine the ranked and filtered search results to give the assistant system (e.g., assistant system 406 in FIG. 4) a final ranking. For example, the ranked search results can be combined with the filtered search results from the relevance filtering module 518 to produce a filtered, ranked list of search results 524. The assistant system (e.g., assistant system 406 in FIG. 4) can use the ranked and filtered list of search results 524 as part of a response to a user query.

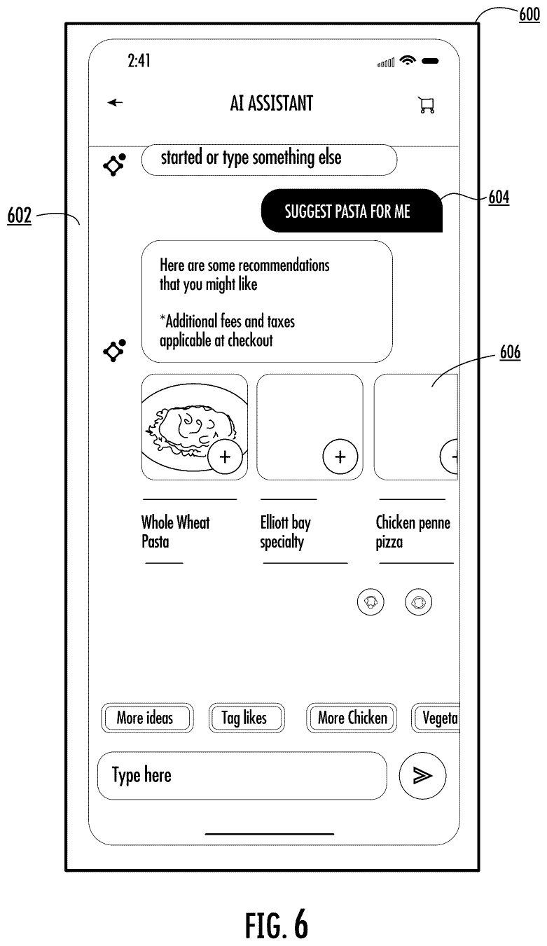

FIG. 6 illustrates an example user interface 600 for enabling an AI assistant in accordance with example embodiments of the current disclosure. In this example, an application for an item delivery service includes a chat interface into which a user can input natural language search queries.

The AI assistant can access the text of these search queries and provide them, along with other information, to a machine learning model (e.g., a large language model) to process the query 604 and provide accurate responses 606. In this example, the AI assistant can also access the food delivery systems vendor and product database to supplement or improve the response of the machine learning model.

In this example, the user submitted the query 604 “suggest pasta for me” into a chat window 602 in the user interface 600. This query 604 is an open-ended natural language query that traditional search systems may have difficulty responding to. The AI assistant system can provide that query 604 to the large language model. The large language model can, along with information provided by the food delivery system database, select potential pasta dishes to recommend to the user. In some examples, the large language model can also use previous orders by the user or the user's general preferences as contextual information when generating query responses. For example, this information can be included in a prompt provided to the large language model as input.

The AI assistant can provide the responses 606 (e.g., recommended dishes) to the user device for display to the user in the user interface 600. In this example, the responses 606 are presented in a carousel that the user can rotate through. Each entry in the carousel includes an image of the recommended dish as well as information about the dish, such as its title, its cost, and so on.

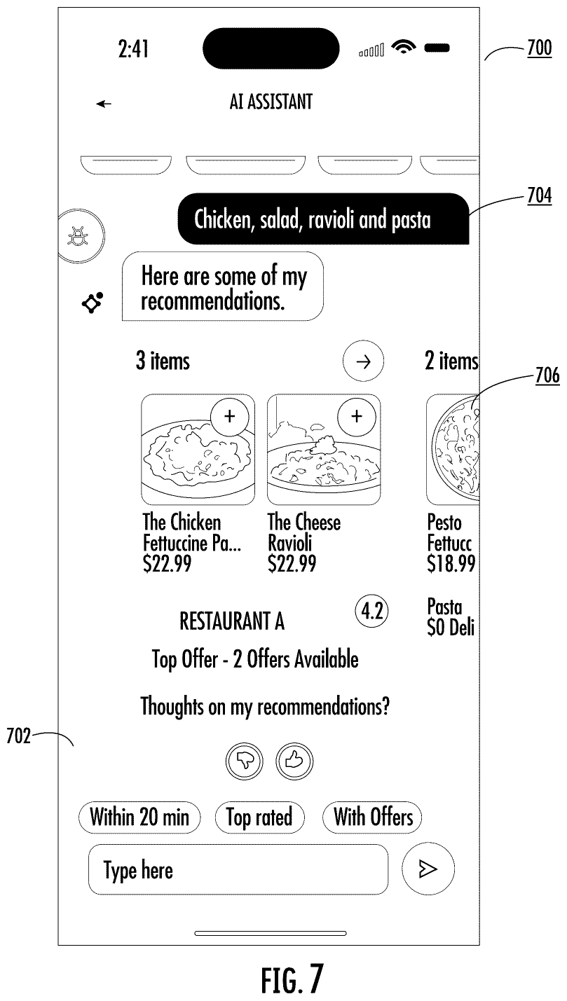

FIG. 7 illustrates an example user interface for enabling an AI assistant in accordance with example embodiments of the current disclosure. In this example, the application associated with the food delivery system can include a user interface 700. The user interface 700 includes a chat window 702. The chat window 702 can allow a user to enter natural language queries and receive responses to those queries.

In some examples, the user can perform an ongoing conversation with the AI assistant system, including a plurality of queries and responses, some of which reference previous queries or responses. In the current example, the user has provided a user response 704 to a previous question asked by the AI assistant system. In this case, the user response 704 states “chicken salad, ravioli, and pasta.” Note that earlier entries in this conversation may have given the AI assistant system more information.

The AI assistant can provide a model output (e.g., the responses 606) to the user response 704, including but not limited to a carousel of options through which the user can swipe. The carousel options can include images of one or more dishes, the names of the dishes, pricing, and other information. For example, the carousel can also include delivery cost and delivery time.

In some examples, the model outputs 706 provided in the carousel can be grouped based on the vendor or restaurant from which they are sourced. In this example, the first entry in the carousel provides three items, while another entry (e.g., restaurant) provides two. In this way, users can simultaneously view several dishes from the same restaurant or choose to view dishes from another restaurant.

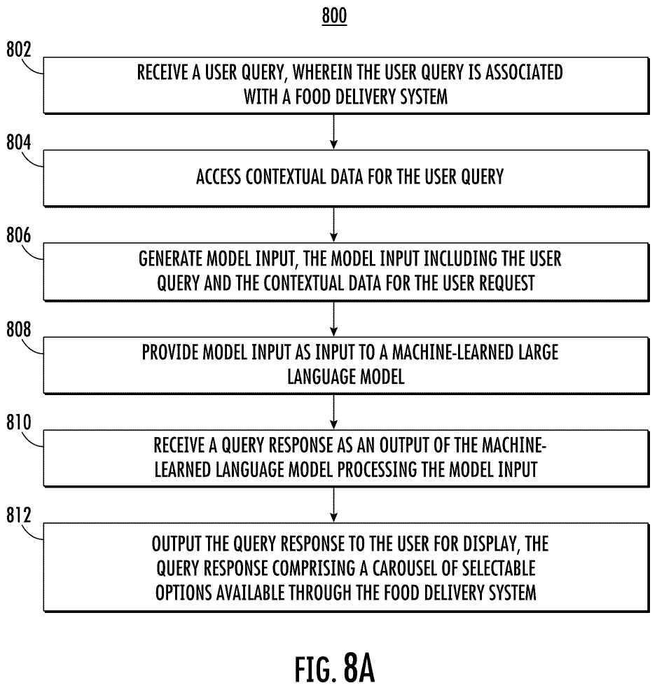

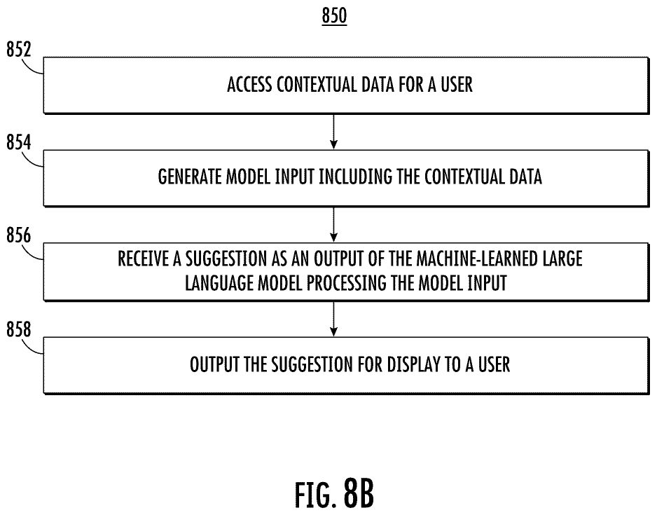

FIG. 8A depicts an example flow diagram for a method 800 for providing an AI assistant to users of an item delivery system according to example embodiments of the present disclosure. One or more portion(s) of the method 800 can be implemented by one or more computing devices such as, for example, the computing devices described herein. Moreover, one or more portion(s) of the method can be implemented as an algorithm on the hardware components of the device(s) described herein. FIG. 8A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 2, 5, 9, 10, 11, and 12.

A computing system can include one or more processors, memory, and other components that, together, enable the computing device to provide an AI assistant to users of an item delivery system. In some examples, the computing device is a server computing system that provides services to users over a computer network.

The computing system can, at 802, receive a user query. The user query can be associated with a food delivery system.

The computing system can, at 804, access contextual data for the user query. In some examples, the contextual data includes one or more of: a user order history, user profile data, and data associated with the food delivery system. The data associated with the food delivery system can include data describing a plurality of vendors and food items provided by those vendors.

The computing system can, at 806, generate model input, the model input including the user query and the contextual data for the user query. The model input can be a prompt, the prompt including past queries and responses in an ongoing conversation. In some examples, the prompt can include a requested schema for the output produced by the model. For example, the requested schema can include a classification of user intent and information describing specific attributes associated with the user response.

In some examples, the computing system can provide, at 808, the model input as input to a machine-learned large language model.

The computing system, at 810, can receive a query response as an output of the machine-learned large language model processing the model input. The model output can include a natural language textual response as part of a conversation with the user. In some examples, the model output includes data organized into a schema defined in the prompt. In some examples, the model output can include search terms and filters. The search terms and prompts can be provided to a search system. The computing system can receive, from the search system, a list of candidate items to recommend to the user.

In some examples, the computing system can rank the list of candidate items. The computing system can populate the carousel of selectable options available based on the ranked list of selectable items. In some examples, the selectable options represent food items available from merchants, and the selectable items are organized in the carousel based on the merchant from which the food items are available.

The computing system can output, at 812, the query response to the user for display, the query response including a carousel of selectable options available through the food delivery system.

In some implementations, the computing system can provide proactive recommendations to a user, without the user providing a user query. FIG. 8B depicts an example flow diagram for a method 850 for proactively providing AI assistance to users of an item delivery system according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 8B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 2, 5, 9, 10, 11, and 12.

At 852, a computing system can access contextual data for a user. In this example implementation, the contextual data can include data indicative of a user's previous purchases. The data indicative of the previous purchases can indicate items previously purchased by the user, the stores or entities from which they were purchased, the times when the items were purchased, the frequency with which the items were purchased, etc.

In some implementations, the data indicative of the previous purchases can include attribute(s) for respective item(s). For example, the attributes can indicate a type of item (e.g., meat, dairy, produce), whether the item is perishable or non-perishable, a quantity, an expiration date, dietary characteristics (e.g., gluten-free, organic), ingredients, allergens, etc.

In some implementations, the contextual data can include data indicative of previously viewed items. The contextual data can include items that the user viewed but did not purchase. Such data may include the amount of time or frequency with which the user viewed an item.

In some implementations, the contextual data can include data indicative of an activity or location of the user. This can include, for example, calendar information indicating the user is going to the beach.

At 854, the computing system can generate model input including the contextual data. As similarly described herein, the model input can be formatted in a manner that can be ingested by a machine-learned large language model that is trained to process the contextual data and proactively suggest items to users based on the contextual data, without a user request. The model input can be provided to the machine-learned large language model at 856.

At 856, the computing system can receive a suggestion as an output of the machine-learned large language model processing the model input. For instance, the model can process the input to determine one or more recommended items for the user to purchase.

At 858, the computing system can output the suggestion for display. The suggestion can include a carousel of selectable options available through the delivery system. Additionally, or alternatively, the suggestion can be provided as a notification that includes one or more items for purchase or delivery and a link for placing an order for that item.

By way of example, the machine-learned large language model may process the contextual data to determine that a user may prefer to order (or re-order) a first item because the model predicts that the user is likely to run out of a particular item (e.g., given the user's previous order frequency) or because the item is likely to expire. In another example, the model may suggest a particular bottle of sunscreen for the user because the processed contextual data indicates that the user is going to the beach, and the user's previous purchases indicate that the user prefers the particular bottle of sunscreen. These suggestions may be provided to the user as content in a user interface of a software application running on a user device.

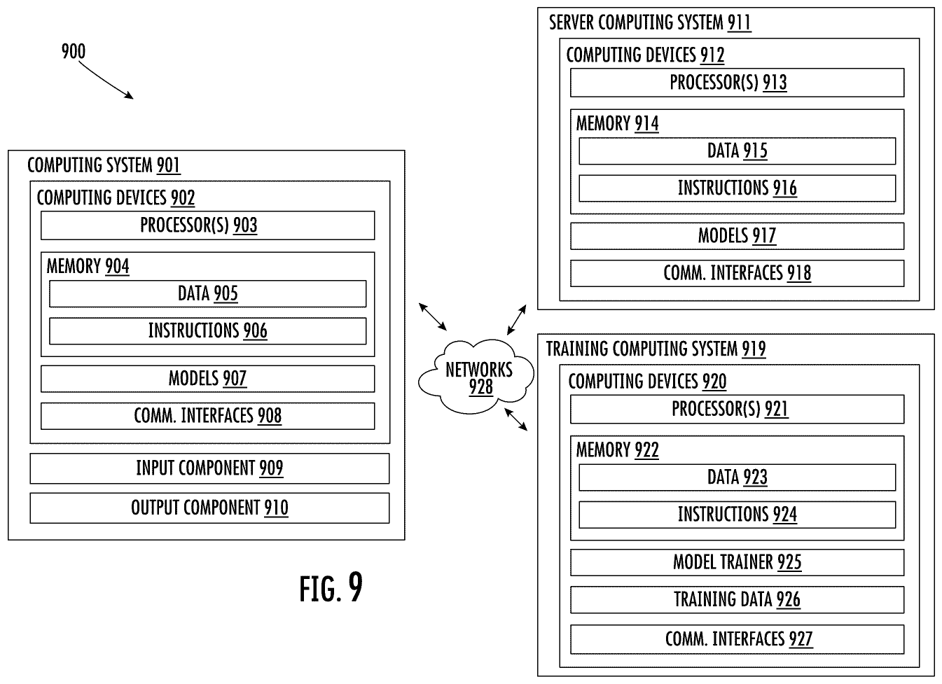

FIG. 9 depicts a block diagram of an example computing system 900 for implementing systems and methods according to example embodiments of the present disclosure. The computing system 900 includes a computing system 901 (e.g., a shopper device 131 corresponding to a shopper), a server computing system 911 (e.g., a network computing system 101, cloud computing platform), and a training computing system 919 communicatively coupled over one or more networks 928.

The computing system 901 can include one or more computing devices 902 or circuitry. For instance, the computing system 901 can include a control circuit 903 and a non-transitory computer-readable medium 904, also referred to herein as memory. In an embodiment, the control circuit 903 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 903 can be programmed by one or more computer-readable or computer-executable instructions stored on the non-transitory computer-readable medium 904.

In an embodiment, the non-transitory computer-readable medium 904 can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium 904 can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 904 can store information that can be accessed by the control circuit 903. For instance, the non-transitory computer-readable medium 904 (e.g., memory devices) can store data 905 that can be obtained, received, accessed, written, manipulated, created, and/or stored. The data 905 can include, for instance, any of the data or information described herein. In some implementations, the computing system 901 can obtain data from one or more memories that are remote from the computing system 901.

The non-transitory computer-readable medium 904 can also store computer-readable instructions 906 that can be executed by the control circuit 903. The instructions 906 can be software written in any suitable programming language or can be implemented in hardware.

The instructions 906 can be executed in logically and/or virtually separate threads on the control circuit 903. For example, the non-transitory computer-readable medium 904 can store instructions 906 that when executed by the control circuit 903 cause the control circuit 903 to perform any of the operations, methods and/or processes described herein. In some cases, the non-transitory computer-readable medium 904 can store computer-executable instructions or computer-readable instructions, such as instructions to perform at least a portion of the method of FIG. 8A, 8B, 13.

In an embodiment, the computing system 901 can store or include one or more machine-learned models 907. For example, the machine-learned models 907 can be or can otherwise include various machine-learned models. In an embodiment, the machine-learned models 907 can include neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In an embodiment, the one or more machine-learned models 907 can be received from the server computing system 911 over networks 928, stored in the computing system 901 (e.g., non-transitory computer-readable medium 904), and then used or otherwise implemented by the control circuit 903. In an embodiment, the computing system 901 can implement multiple parallel instances of a single model.

Additionally, or alternatively, one or more machine-learned models 907 can be included in or otherwise stored and implemented by the server computing system 911 that communicates with the computing system 901 according to a client-server relationship. For example, the machine-learned models 907 can be implemented by the server computing system 911 as a portion of a web service. Thus, one or more models 907 can be stored and implemented at the computing system 901 and/or one or more models 907 can be stored and implemented at the server computing system 911.

The computing system 901 can include one or more communication interfaces 908. The communication interfaces 908 can be used to communicate with one or more other systems. The communication interfaces 908 can include any circuits, components, software, etc. for communicating via one or more networks (e.g., networks 928). In some implementations, the communication interfaces 908 can include for example, one or more of a communications controller, receiver, transceiver, transmitter, port, conductors, software and/or hardware for communicating data/information.

The computing system 901 can also include one or more user input components 909 that receives user input. For example, the user input component 909 can be a touch-sensitive component (e.g., a touch-sensitive user interface of a client device) that is sensitive to the touch of a user input object (e.g., a finger or a stylus). The touch-sensitive component can serve to implement a virtual keyboard. Other examples of user input components include a microphone, a traditional keyboard, cursor-device, joystick, or other devices by which a user can provide user input.

The computing system 901 can include one or more output components 910. The output components 910 can include hardware and/or software for audibly or visually producing content. For instance, the output components 910 can include one or more speakers, earpieces, headsets, handsets, etc. The output components 910 can include a display device, which can include hardware for displaying a user interface and/or messages for a user. By way of example, the output component 910 can include a display screen, CRT, LCD, plasma screen, touch screen, TV, projector, tablet, and/or other suitable display components.

The server computing system 911 can include one or more computing devices 912. In an embodiment, the server computing system 911 can include or is otherwise implemented by one or more server computing devices. In instances in which the server computing system 911 includes plural server computing devices, such server computing devices can operate according to sequential computing architectures, parallel computing architectures, or some combination thereof.

The server computing system 911 can include a control circuit 913 and a non-transitory computer-readable medium, also referred to herein as memory 914. In an embodiment, the control circuit 913 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 913 can be programmed by one or more computer-readable or computer-executable instructions stored on the non-transitory computer-readable medium (e.g., memory 914).

In an embodiment, the non-transitory computer-readable medium (e.g., memory 914) can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium (e.g., memory 914) can store information that can be accessed by the control circuit 913. For instance, the non-transitory computer-readable medium (e.g., memory 914) can store data 915 that can be obtained, received, accessed, written, manipulated, created, and/or stored. The data 915 can include, for instance, any of the data or information described herein. In some implementations, the server computing system 911 can obtain data from one or more memories that are remote from the server computing system 911.

The non-transitory computer-readable medium (e.g., memory 914) can also store computer-readable instructions 916 that can be executed by the control circuit 913. The instructions 916 can be software written in any suitable programming language or can be implemented in hardware. The instructions can include computer-readable instructions, computer-executable instructions, etc.

The instructions 916 can be executed in logically and/or virtually separate threads on the control circuit 913. For example, the non-transitory computer-readable medium (e.g., memory 914) can store instructions 916 that when executed by the control circuit 913 cause the control circuit 913 to perform any of the operations, methods and/or processes described herein. In some cases, the non-transitory computer-readable medium (e.g., memory 914) can store computer-executable instructions or computer-readable instructions, such as instructions to perform at least a portion of the methods of FIG. 9.

The server computing system 911 can store or otherwise include one or more machine-learned models 917. The machine-learned models 917 can include or be the same as the models 907 stored in computing system 901. In an embodiment, the machine-learned models 917 can include an unsupervised learning model. In an embodiment, the machine-learned models 917 can include neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The machine-learned models described in this specification can have various types of input data and/or combinations thereof, representing data available to sensors and/or other systems onboard a vehicle. Input data can include, for example, latent encoding data (e.g., a latent space representation of an input, etc.), statistical data (e.g., data computed and/or calculated from some other data source), sensor data (e.g., raw and/or processed data captured by a sensor of the vehicle), or other types of data.

The server computing system 911 can include one or more communication interfaces 918. The communication interfaces 918 can be used to communicate with one or more other systems. The communication interfaces 918 can include any circuits, components, software, etc. for communicating via one or more networks (e.g., networks 928). In some implementations, the communication interfaces 918 can include for example, one or more of a communications controller, receiver, transceiver, transmitter, port, conductors, software and/or hardware for communicating data/information.

The computing system 901 and/or the server computing system 911 can train the models 907 and 917 via interaction with the training computing system 919 that is communicatively coupled over the networks 928. The training computing system 919 can be separate from the server computing system 911 or can be a portion of the server computing system 911.

The training computing system 919 can include one or more computing devices 920. In an embodiment, the training computing system 919 can include or is otherwise implemented by one or more server computing devices. In instances in which the training computing system 919 includes plural server computing devices, such server computing devices can operate according to sequential computing architectures, parallel computing architectures, or some combination thereof.

The training computing system 919 can include a control circuit 921 and a non-transitory computer-readable medium, also referred to herein as memory 922. In an embodiment, the control circuit 921 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 921 can be programmed by one or more computer-readable or computer-executable instructions stored on the non-transitory computer-readable medium (e.g., memory 922).

In an embodiment, the non-transitory computer-readable medium (e.g., memory 922) can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium (e.g., memory 922) can store information that can be accessed by the control circuit 921. For instance, the non-transitory computer-readable medium (e.g., memory 922) can store data 923 that can be obtained, received, accessed, written, manipulated, created, and/or stored. The data 923 can include, for instance, any of the data or information described herein. In some implementations, the training computing system 919 can obtain data from one or more memories that are remote from the training computing system 919.

The non-transitory computer-readable medium (e.g., memory 922) can also store computer-readable instructions 924 that can be executed by the control circuit 921. The instructions 924 can be software written in any suitable programming language or can be implemented in hardware. The instructions can include computer-readable instructions, computer-executable instructions, etc.

The instructions 924 can be executed in logically or virtually separate threads on the control circuit 921. For example, the non-transitory computer-readable medium (e.g., memory 922) can store instructions 924 that when executed by the control circuit 921 cause the control circuit 921 to perform any of the operations, methods and/or processes described herein. In some cases, the non-transitory computer-readable medium (e.g., memory 922) can store computer-executable instructions or computer-readable instructions, such as instructions to perform at least a portion of the methods of FIG. 8A, 8B, or 13.

The training computing system 919 can include a model trainer 925 that trains the machine-learned models 907, 917 stored at the computing system 901 and/or the server computing system 911 using various training or learning techniques. For example, the models 907, 917 can be trained using a loss function. By way of example, for training a machine-learned segmentation or recommendation model, the model trainer 925 can use a loss function. For example, a loss function can be backpropagated through the model(s) 907, 917 to update one or more parameters of the model(s) 907, 917 (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

The model trainer 925 can train the models 907, 917 (e.g., a machine-learned clustering model) in an unsupervised fashion. As such, the models 907, 917 can be effectively trained using unlabeled data for particular applications or problem domains, which improves performance and adaptability of the models 907, 917.

The training computing system 919 can modify parameters of the models 907, 917 based on the loss function such that the models 907, 917 can be effectively trained for specific applications in an unsupervised manner without labeled data.

The model trainer 925 can utilize training techniques, such as backwards propagation of errors. For example, a loss function can be backpropagated through a model to update one or more parameters of the models (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In an embodiment, performing backwards propagation of errors can include performing truncated backpropagation through time. The model trainer 925 can perform a number of generalization techniques (e.g., weight decays, dropouts, etc.) to improve the generalization capability of a model being trained. In particular, the model trainer 925 can train the machine-learned models 907, 917 based on a set of training data 926.

The training data 926 can include unlabeled training data for training in an unsupervised fashion. In an example, the training data 926 can include unlabeled sets of data indicative of varying degrees of ripeness for produce grocery items and data indicative of confirmed ripeness (e.g., unripe, ripe, over ripe), for a produce grocery items. The training data 926 can be specific to a grocery item to help focus the models 907, 917 on the particular grocery item.

In an embodiment, training examples can be provided by the computing system 901 (e.g., client device of the shopper). Thus, in such implementations, a model 907 provided to the computing system 901 can be trained by the training computing system 919 in a manner to personalize the model 907.

The model trainer 925 can include computer logic utilized to provide desired functionality. The model trainer 925 can be implemented in hardware, firmware, and/or software controlling a general-purpose processor. For example, in an embodiment, the model trainer 925 can include program files stored on a storage device, loaded into a memory and executed by one or more processors. In other implementations, the model trainer 925 can include one or more sets of computer-executable instructions that are stored in a tangible computer-readable storage medium such as RAM, hard disk, or optical or magnetic media.

The training computing system 919 can include one or more communication interfaces 927. The communication interfaces 927 can be used to communicate with one or more other systems. The communication interfaces 927 can include any circuits, components, software, etc. for communicating via one or more networks (e.g., networks 928). In some implementations, the communication interfaces 927 can include for example, one or more of a communications controller, receiver, transceiver, transmitter, port, conductors, software and/or hardware for communicating data/information.

The one or more networks 928 can be any type of communications network, such as a local area network (e.g., intranet), wide area network (e.g., Internet), or some combination thereof and can include any number of wired or wireless links. In general, communication over a network 928 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 9 illustrates one example computing system that can be used to implement the present disclosure. Other computing systems can be used as well. For example, in an embodiment, the computing system 901 can include the model trainer 925 and the training data 926. In such implementations, the models 907, 917 can be both trained and used locally at the computing system 901. In some of such implementations, the computing system 901 can implement the model trainer 925 to personalize the models 907, 917.

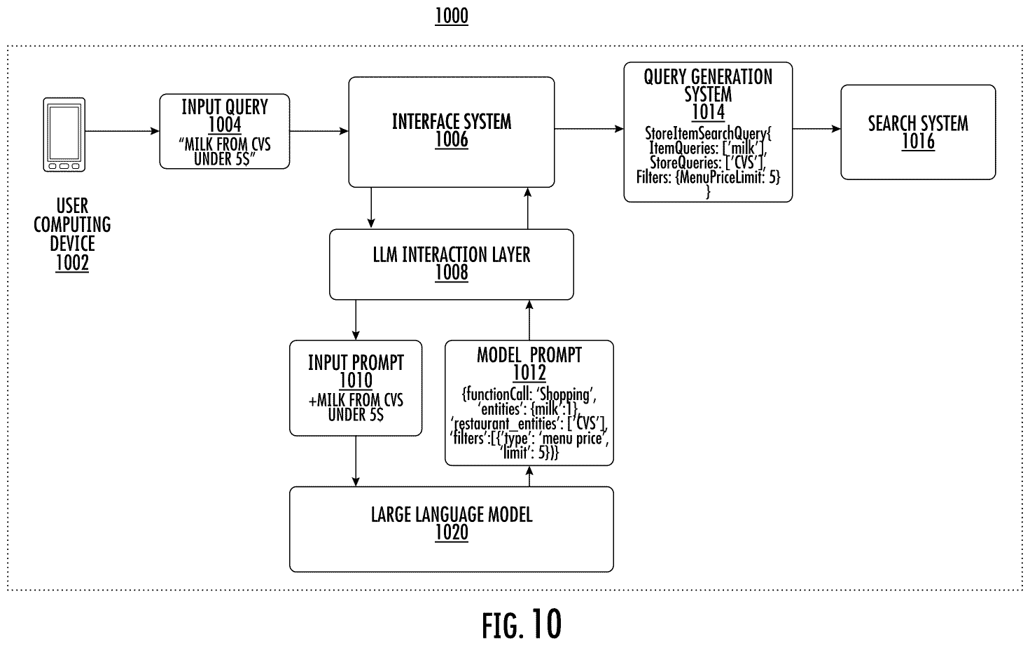

FIG. 10 depicts a block diagram of an example query response system 1000 for implementing systems and methods according to example embodiments of the present disclosure. In this example, a user can provide an input query 1004 to the query response system 1000 via a user computing device 1002. In some examples, the input query can be stated in natural language. For example, the input query 1004 reads “milk from Merchant A under $5.”

The input query 1004 can be transmitted to an interface system 1006. The interface system 1006 can facilitate the processing of input query 1004 to generate a search query (or search query data) that retrieves the most effective results based on the input query 1004. In this example, the interface system 1006 can pass the input query to a large-language model (LLM) interaction layer 1008. The LLM interaction layer 1008 can receive the input query 1004. The input query can generate an input prompt 1010 for the large language model 1020.

In some examples, the input prompt 1010 can include the text of the input query (“Milk from Merchant A under $5), any contextual information (e.g., previous input queries or entries in an ongoing conversation), user preferences (or any other relevant information about the user), and so on. In some examples, once the input prompt has been generated, the LLM interaction layer 1008 can provide the input prompt 1010 to the large language model 1020 as input.

The large language model 1020 can generate a model output 1012. The model output 1012 can be referred to as a model response. The model output 1012 can include data formatted to perform one or more searches that match the criteria received in the input prompt 1010. For example, the model output 1012 can be formatted as JSON data. The JSON data can describe the elements or entities extracted from the input query and assign them to particular fields in a predefined schema. The model output 1012 can be transmitted to the LLM interaction layer 1008. The LLM interaction layer 1008 can serve as a mediator between the interface system 1006 and the large language model 1020. The LLM interaction layer 1008 can return the model output 1012 to the interface system 1006.

Once the interface system 1006 has received the model output 1012, it can transmit the model output 1012 to the query generation system 1014. The query generation system 1014 can generate one or more executable searches based on the information included in the model output 1012. In this example, the executable search is a store item search query. The items query element has the value “melt,” the store queries element has the value “CVS,” and the filters element has the value “menu price limit: five.”

The query generation system 1014 can transmit one or more executable searches to the search system 1016. The search system 1016 can execute the search and return a list of search results to the user computing device 1002 for display to the user.

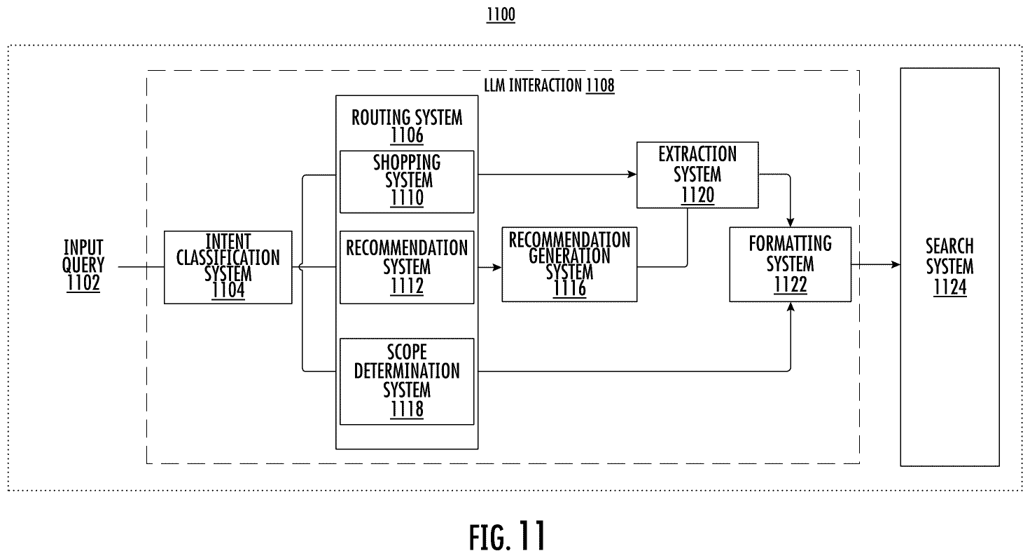

FIG. 11 depicts a block diagram of an example query response system 1100 for implementing systems and methods according to example embodiments of the present disclosure. The LLM interaction layer 1108 can receive an input query from a user (e.g., via a computing network). In some examples, the input query 1102 can be a natural language request from a user.

The LLM interaction layer 1108 can include an intent classification system 1104. The intent classification system 1104 can analyze the input query 1102 to determine one or more indicators of user intent. In some examples, the intent classification system 1104 can include a machine-learned model that receives, as input, the input query 1102 and any context data (e.g., previous input from the user, user history data, user preference data, and so on). The machine-learned model can process the input query 1102 and context data to generate output. The output can include a determined intent. In some examples, the intent can be one of “shopping,” “recommendations,” and “out of scope.”

Once the intent classification system 1104 has determined the intent associated with the input query 1102, the intent classification system 1104 can provide the intent and the input query 1102 to the routing system 1106. The routing system 1106 can access one of a plurality of systems based on the determined intent.

For example, if the determined intent is shopping, the routing system 1106 can provide the input query 1102 to the shopping system 1110. In some examples, shopping intent can be associated with clear purchase intent, looking for specific stores, dishes, or grocery or retail items, and may have complex filtering criteria. In some examples, the shopping system 1110 can provide the input to the extraction system 1120. The extraction system can extract structured search parameters from the query.

For example, if the input query 1102 is “Burger from Burger Store under $30,” the extraction system 1120 can extract “Burger” as an entity, “Burger Store” can be extracted as restaurant_entity, and $30 can be extracted as a filter on menu price. In another example, if the input query 1102 is “Milk and Yogurt from Happy Mart,” milk and yogurt can be extracted as entities and Happy Mart can be extracted as a restaurant_entity.

In other examples, the input query can be “Food and Stuff stores near me that deliver within 20 mins.” The extraction system 1120 can extract “Food and Stuff” as the restaurant_entity, and 20 mins as a filter on delivery time. In another example, the input query 1004 can be “Sushi with BOGO offers.” In this example, the extraction system can extract “Sushi” as an entity and extract “BOGO” as a filter on item promotion, with the value “BOGO.”

In some examples, the determined intent can be recommendations. User intent can be determined to be a request for recommendations when the user seeks suggestions or ideas rather than searching for specific products. When the determined intent is “recommendations,” the routing system 1106 can provide the input query 1102 to the recommendation system 1112. In some examples, the input query 1102 can be provided as part of a prompt. The prompt can include other contextual information such as the time of day, the season, any special diet considerations (e.g., whether the user is vegetarian, vegan, and so on), the user's past cuisine preferences and experiences, and any other relevant information provided by the user. Using an LLM, the recommendation system 1112 can generate a model output. For instance, the LLM can process the prompt as input to generate model output. The model output can include a recommendation response containing relevant food suggestions.

This generated response can be provided to the extraction system 1120 to extract searchable dish entities that can be matched against a database of dish entries (e.g., a catalog). For example, if the input query 1102 is “Healthy food recommendations,” the recommendation generation system 1116 can generate an output such as “Quinoa bowl, avocado toast, grilled salmon.” This text output can be provided to the extraction system 1120. The extraction system 1120 can extract specific food items from the output text. In another example, the example input query 1102 can be “Dinner ideas for two.” The recommendation generation system 1116 can output a model output such as “Pasta, sushi platter, or grilled steak.” This text can be provided to the extraction system 1120 and the relevant entities or items.

In some examples, the routing system 1106 can determine that the intent associated with an input query 1102 is “OutOfScope.” This intent is determined when the query does not align with supported functionalities. This intent can include irrelevant, ambiguous, or unsupported requests, ensuring that non-actionable queries do not consume search resources. Example input queries can be “Help me write code for finding area of a circle,” “Best tourist attractions in Paris,” “Where is my order,” and so on. If the determined intent is “OutOfScope,” the routing system 1106 can provide the input query 1102 to the scope determination system 1118. The scope determination system 1118 can the out of scope system can respond with a message notifying the user that the input query 1102 is out of scope. For instance, the message notifying the user that the input query 1102 is out of scope can be provided based on the system determining that the intent is not within the determined scope of the query response system 1100.

Once the routing system 1106 has provided the input query 1102 to a particular processing system (e.g., one of the shopping system 1110, the recommendation system 1112, or the scope determination system 1118), the output of the shopping system 1110 and the recommendation system 1112 (after being processed by the recommendation generation system 1116) can be provided to the extraction system 1120.

The extraction system 1120 can extract a variety of items from the model output. For example, the variety of extracted items can include entities, exclusion entities, or filters such as promotions, price limits, delivery preferences, dietary preferences, locations, and so on.

Entities can be any term that identifies restaurants, store names, dishes, grocery items, cuisines, food categories, etc. These entities can be used as search terms when searching a database of potential food items. Exclusion entities can identify dishes, store names, restaurants, food categories, or cuisines to be excluded from search results. Filters can include constraints on the search results based on the input query 1102. For example, figures can include promotions. Promotions refer to specific sales or discounts that are available. Examples of promotions can include store promotions, including specific item promotion types like Buy One Get One (BOGO), flat off, and so on.

Another example of filters can be price limits. Price limits can be currency values that represent the total the user is willing to spend on an order (or a specific item within an order). For example, an input query can request that the food items be “under $20”. Another filter can be delivery preferences. Delivery preferences can represent the user preferences for delivery time, delivery fee, scheduling, and so on.

Another filter can be dietary preferences. For example, in input query 1102, a user can list one or more of their dietary preferences. Specifically, dietary preferences can include “vegetarian-friendly,” “high-protein meals,” and so on. Another filter type can be a location. Thus, in addition to food and filter extraction, the extraction system 1120 can detect location-based queries. If a user specifies a geographic preference (may include a city, a neighborhood, or other specific place names), it is extracted and added to the location field.

In some examples, if the user intent is determined to be shopping, the extraction system 1120 can strictly extract entities from the user query without introducing additional suggestions. For example, if the input query is “Find me sushi from a top-rated restaurant under $25,” the extraction system can extract sushi, price filter ($25), and a ratings filter on the restaurants. Alternatively, if the input query 1102 is “Order organic almond milk from grocery store A,” the extraction system 1120 can extract a product (organic almond milk) and a store (grocery store A).

In some examples, if the user intent is “recommendations,” the recommendation system 1112 can first generate recommendations in the text response field. The recommendations can extract searchable entities from this output. For example, if the input query 1102 states “What are some healthy food recommendations?”, the recommendation system 1112 can generate output that includes “1. Quinoa bowl 2. avocado toast 3. grilled salmon.” Based on the recommendation, the extraction system can then extract quinoa bowl, avocado toast, and grilled salmon as search entities. In another example, the input query 1004 can state, “Dinner ideas for two.” The recommendation generation system 1116 can generate “1. Pasta 2. sushi platter 3. grilled steak.” The extraction system 1120 can extract pasta, sushi platter, and grilled steak as entities from the generated recommendation. This approach ensures the search pipeline remains structured and efficient and prevents recommendation queries from being incorrectly treated as strict item searches.

Once the intent of the input query 1102 has been determined and the extraction system has extracted entities, filters, and locations, this information can be passed to the formatting system 1122. The formatting system 1122 can structure the extracted entities, filters, and locations into a predefined schema (e.g., a JSON schema) associated with the search system 1124. Formatting the output of the extraction system can enable the LLM interaction layer 1108 to execute a search on the search system 1124 using the LLM-based results extracted from the input query 1102.

This formatting system can validate the machine-learned model output for correctness and sanity to mitigate the risks from potential model errors. Such validations at the backend give more insights, debuggability, and flexibility to add and extend guard rails for postproduction model outputs.

For example, if the input query 1102 is “Toothpaste in Santa Monica from Store A under $5 and delivering in 25 mins,” the intent can be determined to be shopping, and the output schema can be:

{
“location”: “Santa Monica”,
“entities”: “toothpaste” :1 },
“restaurant_entities”: [“Store A”],
“filter”: [“type”: “menu price”, “limit”: 5 },
{“type”: “delivery time”, limit”: 25}
]}

Once the output scheme has been generated, the output schema can be transmitted to the search system 1124. The search system 1124 can perform a search query through a relevant database. The search results can be received from the search system 1124 and displayed to the user.

In another example, if input query 1004 states “Healthy Food Recommendations,” the intent can be determined to seek recommendations. The output schema can be as a series of recommended foods, as seen below:

{
“entities”:
“salad”: 1,
“grilled chicken”: 1,
“salmon”: 1,
“oatmeal”: 1,
“greek yogurt”: 1,
“lentil soup”: 1,
“brown rice bowl”: 1,
“tofu stir-fry”: 1,
“quinoa salad”: 1,
“veggie wrap”: 1
},

Based on these output schema, the system can generate a text response that reads “Here are some healthy food options: \n\n1. Salad\n2. Grilled Chicken\n3. Salmon\n4. Oatmeal\n5. Greek Yogurt\n6. Lentil Soup\n7. Brown Rice Bowl\n8. Tofu Stir-Fry\n9. Quinoa Salad\n10. Veggie Wrap.” This can be displayed to a user.

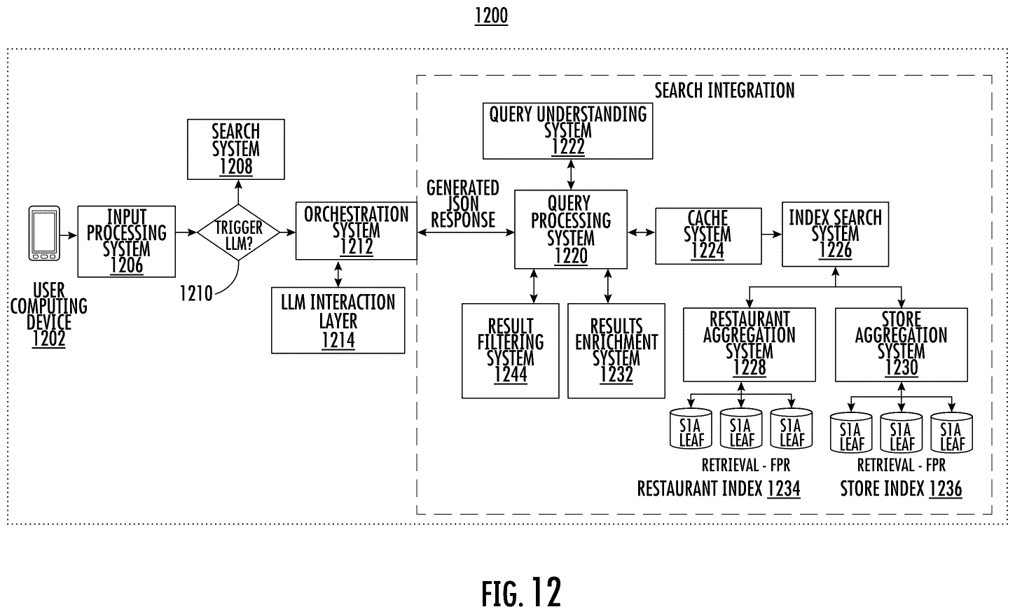

FIG. 12 depicts a block diagram of an example query response system 1200 for implementing systems and methods according to example embodiments of the present disclosure. In some examples, a user computing device 1202 can submit an input query to an input processing system 1206. In some examples, the user computing device 1202 includes an application associated with query response system 1200. In other examples, the user uses a web browser to submit the input query to the query response system 1200.

An input processing system 1206 can receive the input query. Instead of processing every query directly with the LLM-based search stack, this approach can first query an LLM to determine if another LLM call is necessary. The first call acts as a query classifier, and only if the query is deemed complex does the second call trigger the full LLM-based search. As such, the multi-call approach can provide for reduction in computing resource utilization when a query is not deemed to be complex and does not warrant a second call to the trigger the full LLM-based search. This helps to provide a technical solution to a technical problem associated with the resource consumption that occurs when a call is made to an LLM.

In some examples, the input processing system can evaluate the input query to determine, at 1210, whether the query response system should trigger the LLM or not. For example, when determining whether to trigger the LLM, the input processing system 1206 can determine a type associated with the input query. The type of input query can be used to determine whether or not to employ the LLM system.

In some examples, the LLM system can be employed if the input query is one of: a query with multiple filters in a single query, long/complex queries, natural language queries, queries with filters and sorting criteria (e.g., delivery time, delivery fee, promotions, distance), location-based queries, multi-entity queries, or recommendation queries.

When determining whether a particular query is long enough to trigger a large language model, the input processing system 1206 can generate a string of tokens representing the input query. Input processing system 1206 can determine whether the number of tokens exceeds a threshold value. For example, if a query exceeds 5 tokens, the query can be considered complex, and an LLM-backed search may be triggered.

The threshold value can be a static predetermined threshold value. In other examples, the threshold value can be dynamic. For example, the threshold value can be set by the query response system based on one or more factors such as the current system compute resource utilization. For example, if the query response system is processing an above average number of requests, the query response system can increase the threshold value so that fewer input queries are categorized as complex. Conversely, if the number of requests is below average, the threshold value can be lowered, and a larger proportion of requests can be categorized as complex. In this way, the query response system can adjust the number of complex input queries based on available resources or some other factor.

In some examples, if the input processing system 1206 determines that the impact query does not need to trigger, at 1210, the large language model system, the input query can be passed to the search system 1208. The search system 1208 can identify one or more results for the input query.

If the input processing system 1206 determines that the input query is complex and thus needs to trigger the large language model system, the input query can be passed to the orchestration system 1212. The orchestration system 1212 can provide the input query to the LLM interaction layer 1214. The LLM interaction layer 1214 can provide the input query to a machine-learned model. The machine-learned model can provide a model output.

The orchestration system 1212 can provide the model output to the query processing system 1220. The model output can be formatted based on a predefined schema (e.g., in JSON). The predefined schema can include a series of fields and values for each field.

The query processing system 1220 can process the model output and access a series of sub-systems to execute a search based on the model output. The model output can extract entities from the model output. The extracted entities from the LLM response can be stored by a cache system 1224 for use by the index search system 1226 during searching and post-searching. For example, the query processing system 1220 can store items the user is searching for in an entities field, stores to retrieve results from in a restaurant_entities field, store categories to include in a restaurant_category_entities field, items to exclude in a entities_exclusion_list field, cuisines to exclude in a cuisines_exclusion_list field, and so on.

In some examples, the query processing system 1220 can extract filters from the model output and adapt them to search system filters. For example, the model output can contain a filter field containing a list of filters extracted based on the user intent. These filters would be extracted and adapted to the data format or data type used by the search system. In this way, the filters can be used while searching using the search system.

In some examples, the model input can have a populated location field. If so, the query processing system 1220 can use a location determination system to get exact location coordinates corresponding to the location text populated in the location field of the model output (e.g., formatted in JSON). An index search system 1226 can use the extracted location coordinates to identify useful search results.

The query processing system 1220 can provide the model output, extracted entities, and the input query to the query understanding system 1222. The query understanding system 1222 can further extract various attributes from the model output including brands, the number of items to be ordered or purchased, the specific facet to be searched, and so on. The query understanding system 1222 can enable searching both the restaurant index 1234 and the store index 1236 (e.g., using federated search).

Once the query understanding system 1222 has modified or updated the model output, it can be returned to the query processing system 1220. The query processing system 1220 can transmit the updated model output to the index search system 1226 to conduct a search of the restaurant index 1234 and the store index 1236.

The index search system 1226 can retrieve search results based on the items, stores, and store categories extracted from the model output. More specifically, the search system 1226 can access both the restaurant aggregation system 1228 (which retrieves data from the restaurant index 1234) and the store aggregation system 1230 (which retrieves data from the store index 1236). The search results can be transmitted to the query processing system 1220.

The query processing system 1220 can provide the search results to the results enrichment system 1232. The results enrichment system 1232 can supplement search results with complete store and item data, which is required for the subsequent filtering phase. When promotion filters are specified in the input query, the results enrichment system 1232 can supplement both store and item data to enable filtering based on promotion attributes. Otherwise, the results enrichment system 1232 can only supplement store-level information needed for basic store filters like ratings, delivery fees, and ETAs. The results enrichment system 1232 can return the enriched results to the query processing system 1220.

Once the search results have been retrieved and the search results have been supplemented, the query processing system 1220 can provide the enriched search results to the result filtering system 1244. The result filtering system 1244 can apply the filters extracted from the model output on the supplemental data, processing both store-level data (delivery fee, time, menu price, rating) and item-level filters (promotions, deals). The result filtering system 1244 can apply exclusion filters based on excluded cuisines and items. The result filtering system 1244 can return the filtered search results to the query processing system 1220.

The query processing system 1220 can rank the search results after the result filtering system 1244 has filtered them. Once the search results have been ranked, the query processing system 1220 can transform the final search results into a structured feed response by generating feed items to be used for presentation. The generated feed can be transmitted for display at the user computing device. The generated feed can be presented to the user in a variety of formats (e.g., a selectable list, an item carousel, and so on).

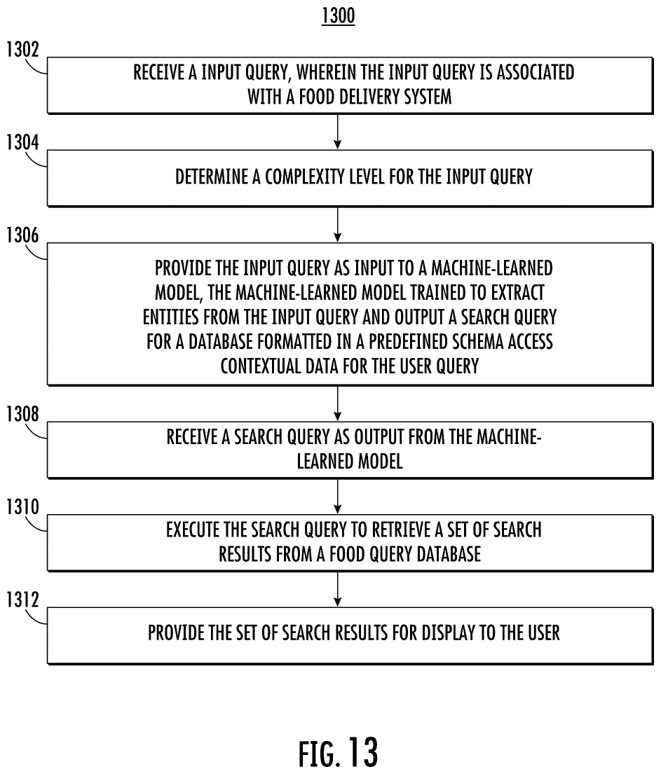

FIG. 13 depicts an example flow diagram for a method 1300 for using a large language model to supplement a search system according to example embodiments of the present disclosure. One or more portion(s) of the method 1300 can be implemented by one or more computing devices such as, for example, the computing devices described herein. Moreover, one or more portion(s) of the method can be implemented as an algorithm on the hardware components of the device(s) described herein. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 2, 5, 9, 10, 11, and 12.

A computing system can include one or more processors, memory, and other components that, together, enable the computing device to respond to search queries from uses using a large language model. In some examples, the computing device is a server computing system that provides services to users over a computer network.

The computing system can, at 1302, receive a user query. The user query can be associated with a food delivery system.

The computing system can, at 1304, determine a complexity level for the input query. In some implementations, the computing system can determine that the complexity level satisfies a complexity threshold. A complexity level can be determined based on one or more factors including a query type of the input query, the number of extracted entities, the length and/or complexity of the input query, and so on. In some examples, a machine-learned model can be trained to generate a complexity score between 0 and 1. The complexity score can be compared to the complexity threshold. If the complexity score for a respective input query exceeds the complexity threshold, the input query is determined to be complex.

The complexity threshold can be adjusted to increase or decrease the number of input queries that are processed by the machine-learned model. For example, if the volume of input queries is high, the complexity threshold can be raised to reduce the percentage of input queries that are determined to be complex. Similarly, if the volume of input queries is low, the complexity threshold can be lowered, increasing the percentage of input queries determined to be complex. For example, if the complexity scores are between 0 and 1, the complexity threshold can be set to 0.8.

The computing system can, at 1306, provide, based on the complexity level satisfying the complexity threshold, the input query as input to a machine-learned model. The machine-learned model can be trained to extract entities from the input query and output a search query for a database formatted in a predefined schema.

The computing system can, at 1308, receive a search query as output from the machine-learned model. The search query can include information extracted from the input query. For example, the input query can include restaurants, dishes, food items, times, delivery needs, exclusion entities, or filters such as promotions, price limits, delivery preferences, dietary preferences, locations. The search query can be formatted based on a predefined schema used by a search system to search a database.

The computing system can, at 1310, execute the search query to retrieve a set of search results from a food query database. For example, the computing system can use the data included in the search query to retrieve data from an indexed database. The entities extracted from the input query can be used to identify the specific items in the database that are responsive to the input query. The items retrieved from the database can be ranked and ordered based on their relevance to the input query into a set of search results.

The computing system can, at 1312, provide the set of search results for display to the user. For instance, the computing system can transmit data comprising instructions that are executable by one or more processors to cause a user interface to update to provide the set of search results for display.

Computing tasks discussed herein as being performed at certain computing device(s)/systems can instead be performed at another computing device/system, or vice versa. Such configurations can be implemented without deviating from the scope of the present disclosure. The use of computer-based systems allows for a wide variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” can be used interchangeably herein. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computer-implemented method, the method comprising:
receiving, by a computing system with one or more processors, a user query, wherein the user query is associated with a food delivery system;
accessing, by the computing system, contextual data for the user query;
generating, by the computing system, model input, the model input including the user query and the contextual data for the user query;
providing, by the computing system, model input as input to a machine-learned large language model;
receiving, by the computing system, a query response as an output of the machine-learned large language model processing the model input; and
outputting, by the computing system, the query response to the user for display, the query response comprising a carousel of selectable options available through the food delivery system.

2. The computer-implemented method of claim 1, wherein the contextual data includes one or more of a user order history, user profile data, and data associated with food delivery system.

3. The computer-implemented method of claim 2, wherein the data associated with the food delivery system can include data describing a plurality of vendors and food items provided by those vendors.

4. The computer-implemented method of claim 1, wherein the model input is a prompt, and the prompt includes past queries and responses in an ongoing conversation.

5. The computer-implemented method of claim 4, wherein the model output includes data organized into a schema defined in the prompt.

6. The computer-implemented method of claim 1, wherein the query response comprises a natural language textual response as part of a conversation with the user.

7. The computer-implemented method of claim 1, wherein the model output include search terms and filters.

8. The computer-implemented method of claim 7, wherein the search terms and prompts are provided to a search system, the method further comprising:
receiving, from the search system, a list of candidate items to recommend to the user.

9. The computer-implemented method of claim 8, further comprising:
ranking, by the computing system, the list of candidate items; and
populating the carousel of selectable options available based on the ranked list of selectable items.

10. The computer-implemented method of claim 9, wherein the selectable options represent food items available from merchants and wherein the selectable are organized in the carousel based on the merchant from which the food items are available.

11. The computer-implemented method of claim 9, wherein the prompt includes a requested schema for the output produced by the model.

12. A computing system, comprising:
one or more processors; and
one or more non-transitory, computer-readable media storing instructions that are executable by the one or more processors to cause the computing system to perform operations, the operations comprising:
receiving, by a computing system with one or more processors, a user query, wherein the user query is associated with a food delivery system;
accessing, by the computing system, contextual data for the user query;
generating, by the computing system, model input, the model input including the user query and the contextual data for the user query;
providing, by the computing system, model input as input to a machine-learned large language model;
receiving, by the computing system, a query response as an output of the machine-learned large language model processing the model input; and
outputting, by the computing system, the query response to the user for display, the query response comprising a carousel of selectable options available through the food delivery system.

13. A computer-implemented method, the method comprising:
accessing, by a computing system with one or more processors, contextual data for a user;
generating, by the computing system, model input, the model input including the contextual data for the user;
providing, by the computing system, model input as input to a machine-learned large language model;
receiving, by the computing system, a suggestion as an output of the machine-learned large language model processing the model input; and
outputting, by the computing system, the suggestion for display to a user.

14. The computer-implemented method of claim 13, wherein the contextual data includes one or more of a user order history, user profile data, and data associated with food delivery system.

15. The computer-implemented method of claim 14, wherein the data associated with the food delivery system can include data describing a plurality of vendors and food items provided by those vendors.

16. The computer-implemented method of claim 14, wherein the user order history includes one or more of: one or more items that were previously purchased by the user, one or more entities from which the one or more items were purchased, one or more times when the one or more items were purchased, and a frequency with which the one or more items are purchased.

17. The computer-implemented method of claim 13, wherein the suggestion includes a predicted next order date for a particular item and method further comprises:
determining, by the computing system, a current date and a current time; and
determining, by the computing system and based on the current date and the current time to display the suggestion to the user at the current time.

18. The computer-implemented method of claim 13, wherein the model input is a prompt.

19. The computer-implemented method of claim 13, wherein the suggestion is displayed within a carousel of selectable options available through a food delivery system.

20. The computer-implemented method of claim 13, wherein the contextual data include previously submitted input queries.
